(19) United States
(12) Patent Application Publication
(10) Pub. No.: US 2005/0132499 A1
(43) Pub. Date: Jun. 23, 2005

(54) Process for leather making using saline water

(75) Inventors: Nagarajan Vedaraman, Chennai (IN); Kuttalam Iyappan, Chennai (IN); Victor John Sundar, Chennai (IN); Boppana Venkata Ramabrahmam, Chennai (IN); Chellappa Muralidharan, Chennai (IN)

Correspondence Address: JOHN RICHARDS;c/o LADAS & PARRY, 26 WEST 61st STREET, NEW YORK, NY, 10023, US

(73) Assignee: COUNCIL OF SCIENTIFIC & INDUSTRIAL RESEARCH

(21) Appl. No.: 10/811,236

(22) Filed: Mar. 26, 2004

(30) Foreign Application Priority Data
Aug. 14, 2003 (IN) 1000/DEL/2003

(51) Int. Cl. C14C 1/00; G03C 1/494

(52) U.S. Cl. 8/94.15

(57) ABSTRACT

The present invention provides a process to use saline water having more than 25000 ppm of salinity for leather processing by treating the raw hides/skins with salts of alkali metals/alkali earth metals.

### FIELD OF INVENTION

The present invention relates to a process for leather making using saline water. More particularly the invention relates to a process for making limed pelt using water having salinity in the range of 12000 to 25000 ppm. The process has enormous application potential in leather processing industry to utilize sources of water having high salinity including sea water. It is also envisaged to have abundant application in other similar processing industries.

### BACKGROUND AND PRIOR ART

Leather processing involves removal of non-collagenous materials present in hides/skins and converting the remaining collagenous substance into leathers of different functional as well as aesthetic properties using different combinations of chemical treatment and mechanical operations. Raw hides and skins are first subjected to soaking operation whereby they are treated with water optionally in presence of other auxiliaries like surface active agents to remove adhering dirt, dung etc and also to ensure ample rehydration to facilitate the subsequent removal of non-collagenous materials followed by tanning of the collagenous substance. The soaked stock in most of the cases of leather processing is subjected to dehairng using chemical, enzymatic or even a combination system, unless the process is intended for hair-on tannage. It is however required to remove the flesh layer of the rehydrated hides/skins at this stage. The operation is known as liming, whereby the rehydrated hides/skins, both dehaired or otherwise, are treated with alkali like lime or sodium hydroxide in order to swell the protein that facilitates easy removal of the non-collagenous layer by mechanical means called fleshing. The extent of swelling plays a major role in shaping the ultimate characteristics of the final leathers. All these operations are commonly referred to as beam house operations, which ultimately decide the quality of the final leather. The defleshed hide/skin is usually referred to as pelt, which is subsequently subjected to several pretanning, tanning and different post tanning operations to manufacture finished leather. As reported in a communication from M/s Clariant (Hide Lines ,Vol. 6, pp1, December 2001), leather is made in the beam house itself. Conventionally, water has been the basic medium for leather processing. It is estimated that about 35-40 litres of water per kilo of rawhide or skin is used for processing. As reported by John Sundar et al. (Journal of Scientific And Industrial Research, pp 443-450, June, 2001.), the current annual requirement of water for leather industry is about 30 billion liters. But the water that is conventionally used for leather processing, satisfies certain quality requirements. It is a common practice in leather industry to use salt as a de-swelling agent. It implies that saline water results in repression of swelling of the hides/skins.

On the other hand, with growing population and increase in per capita consumption of water, the water availability for industrial application is bound to face depletion. World bank has recently estimated that the demand of water would be expected to grow by over 650% in next three decades. The sustainability of processing industries like leather tanning, that consumes major share of water, is thus threatened by growing water resource crunch. Attempts are therefore being made to ensure economy of water by exploring the possibility of adopting water less/less water system or even reusing the same. Several attempts are also being made to explore alternate sources of water. 80% of earth's crust is estimated to be covered by water of which 97.5% is represented by seawater. The major limitation associated with the sea water is that it contains significant quantities of salts and minerals. Salinity of typical sea water ranges between 22000-35000 ppm. This high level of salinity is bound to affect the leather processing adversely. Use of untreated seawater results in poor opening up of fibre structure as evidenced by fallen (non-swollen) condition of the substrate and non loosening of flesh adhered in the raw material, resulting in inadequate defleshing. This is why this vast potential source of water has so far been untapped in leather processing industry due to its self limiting effects on the leather quality.

No prior art is available on the use of sea water or other similar water with salinity more than 10000 ppm for making pelt. Novelty of the present invention is to use the sea water with a sodium chloride concentration up to 30000 ppm.

### OBJECT OF THE INVENTION

The main objective of the present invention is to provide a novel process for leather making using saline water, which obviates the limitations cited above. Still in another object of the present invention is to utilize water with high dissolved solid content and salinity, to be used as a medium for leather processing which was considered unviable hither to.

Yet in another object of the present invention is to develop a process that affords to use of sea water for leather processing, thereby creating a near inexhaustible alternative resource for leather processing

### SUMMARY OF THE PRESENT INVENTION

The present invention discloses a process for leather making using saline water. More particularly the invention relates to a process for making limed pelt using water having salinity in the range of 12000 to 30000 ppm. The process has enormous application potential in leather processing industry to utilize sources of water having high salinity including sea water. It is also envisaged to have abundant application in other similar processing industries.

### DETAILED DESCRIPTION OF THE INVENTION

Accordingly the present invention deals with a process for leather making using saline water, said process comprising the steps:
(i) treating raw hides/skins with saline water having sodium chloride concentration in the range of 11000 to 30000 by not less than 300% w/v, in the presence of salt by not less than 0.04% w/v, either individually or in any combination thereof, for a period in the range of 10 hrs to 14 hours to obtain soaked hides/skins,
(ii) treating soaked hides/skins with alkali metal by not less than 2% w/w in combination with saline water by not more than 200% w/v for a period in the range of 6 hours to 48 hours, and
(iii) fleshing the treated hides/skins of step (ii) to get fleshed pelt and is conventionally converted into finished leather.

In another embodiment of the present invention wherein the sodium chloride concentration of saline water is in the range of 20000 to 30000 ppm.

Still in another embodiment of the present invention, wherein the salt is selected from a group comprising of alkali metal and an alkali earth metal.

Yet in another embodiment of the present invention, wherein the salt of alkali metals used is selected from the group consisting of sodium hydroxide, sodium carbonate, sodium bicarbonate either individually or in combinations thereof.

Further in another embodiment of the present invention, wherein the salt of alkali earth metals is selected from calcium hydroxide, magnesium hydroxide either individually or in combinations.

In one more embodiment of the present invention, wherein the skin/hides obtained from animals.

Further in another embodiment of the present invention, wherein the animals selected from a group comprising cow, goat, sheep and buffalo.

The process of the present invention is described below in detail.

Raw hides/skins are treated with 300% w/v, of saline water having more than 25000 ppm of chlorides in presence of not less than 0.04% w/v of a salt of alkali metal or an earth metal, either individually or in any combination, for a period of not less than 12 hrs. to get soaked hides/skins. These soaked hides/skins are then treated with not less than 2% w/w, of alkali metal in combination with not more than 200% w/v, of saline water for a period of not less than 6 hrs. The resulting stock is mechanically fleshed to get fleshed pelt, which is subjected to conventional tanning and other post tanning operations to get finished leather.

The inventive step of the present invention lies in the treatment of raw hides/skins with salts of alkali metals/alkali earth metals to facilitate, using saline water having more than 25000 ppm of salinity for leather processing, thereby suggesting not only an option to utilize the vast source of sea water and other water sources having high salinity, that otherwise poses environmental problems, for useful industrial applications, but also a step towards solving the problem of enormous water requirement by such processing industries as leather industry.

### EXAMPLES

The following are furnished by way of illustration only and therefore, should not be construed to limit the scope of the present invention.

### Example 1

5 Goat skins weighing 6 kg were taken in a pit, which was flooded with 18 liters of water containing 30,000 ppm of chlorides. 8 gm of Ca(OH)₂ were added to the pit with stirring. After a period of 12 hrs, the skins were found to be well-soaked. The water was drained. The soaked skins were then treated with 12 litres of saline water along with 600 g of lime 60 g of sodium sulfide 120 g of soda ash for a period of 48 hours with intermittent stirring. The skins were then fleshed using fleshing machine to produce fleshed pelts.

These fleshed pelts were chrome tanned to produce chrome tanned leathers.

### Example 2

4 sheep skins weighing 5 kilos were soaked using 15 litres of water containing salinity of 28000 ppm 10 g Mg(OH)₂, 10 g Na₂CO₃ and 10 g NaOH were added to the pit with stirring. After a period of 14 hrs, the skins were found to be well-soaked. The water was drained. The soaked skins were then treated with 10 litres of saline water along with 500 g of lime 40 g of sodium sulfide 100 g of soda ash for a period of 36 hours with intermittent stirring. The water was then drained The skins were then fleshed using fleshing machine to produce fleshed pelts.

These fleshed pelts were chrome tanned to produce chrome tanned leathers.

### Example 3

2 cow calf skins weighing 10 kilos were soaked using 30 litres of water containing salinity of 30000 ppm. 24 g Ca(OH)₂ and 20 g NaHCO₃ were added to the pit with stirring. After a period of 12 hrs, the skins were found to be well-soaked. The water was drained. The soaked skins were then treated with 20 litres of saline water along with 500 g of lime 100 g of sodium sulfide 200 g of soda ash for a period of 48 hours with intermittent stirring. The water was then drained The skins were then fleshed using fleshing machine to produce fleshed pelts. These fleshed pelts were chrome tanned to produce chrome tanned leathers.

### ADVANTAGES OF THE INVENTION

The main advantages of the present invention are the following.
1) The process provides for an opportunity to utilize water with high dissolved solid content and salinity, to be used as a medium for leather processing which was considered unviable hither to.
2) The process affords use of sea water for leather processing, thereby creating a near inexhaustible alternative resource for leather processing
3) The process is simple and does not require sophisticated manpower or infrastructure
4) The process is reproducible and can be adopted by all scale of tanners irrespective of the production capacities.

1. A process to obtain fleshed pelt using saline water, said process comprising the steps of:
i) treating raw hides/skins with saline water having sodium chloride concentration in the range of 11000 to 30000 ppm by not less than 300% w/v, in the presence of salt by not less than 0.04% w/v, either individually or in any combination thereof, for a period in the range of 10 hrs to 14 hours to obtain soaked hides/skins,
ii) treating soaked hides/skins with alkali metal by not less than 2% w/w in combination with saline water by not more than 200% w/v for a period in the range of 6 hours to 48 hours, and
iii) fleshing the treated hides/skins of step (ii) to obtain the fleshed pelt.

2. A process as claimed in claim 1, wherein the sodium chloride concentration of saline water is in the range of 11000 to 30000 ppm.

3. A process as claimed in claim 1, wherein the salt is selected from the group consisting of alkali metal and an alkali earth metal.

4. A process as claimed in claim 1, wherein the salt of alkali metals used is selected from the group consisting of sodium hydroxide, sodium carbonate, sodium bicarbonate either individually or in combinations thereof.

5. A process, as claimed in claim 1, wherein the salt of alkali earth metals is selected from calcium hydroxide, magnesium hydroxide either individually or in combinations.

6. A process as claimed in claim 1, wherein the skin/hides obtained from animals.

7. A process as claimed in claim 6, wherein the animals are selected from the group consisting of a cow, goat, sheep and buffalo.

8. A process as claimed in claim 1, wherein the fleshed pelt is used for preparing the finished leather.
